(19) United States
(12) Patent Application Publication
(10) Pub. No.: US 2015/0093838 A1
(43) Pub. Date: Apr. 2, 2015

(54) MICROFLUIDIC VALVE SYSTEMS

(71) Applicants: James P. Landers, Charlottesville, VA (US); Yiwen Ouyang, Charlottesville, VA (US); Jingyi Li, Charlottesville, VA (US)

(72) Inventors: James P. Landers, Charlottesville, VA (US); Yiwen Ouyang, Charlottesville, VA (US); Jingyi Li, Charlottesville, VA (US)

(21) Appl. No.: 14/503,955

(22) Filed: Oct. 1, 2014

Related U.S. Application Data
(60) Provisional application No. 61/885,328, filed on Oct. 1, 2013.

(51) Int. Cl. B01L 3/00; B32B 38/00; B32B 38/10; B32B 37/18

(52) U.S. Cl. CPC B01L 3/502746; B01L 3/502707; B32B 37/18; B32B 38/145; B32B 38/10; B01L 2400/088; B01L 2300/165; B01L 2300/0887; B01L 2300/0816; B32B 2307/412; B32B 2310/0843; B32B 2439/00
USPC 436/180; 422/503; 156/182

(57) ABSTRACT

A microfluidic device having a chip defining fluid channels and having toner patches printed within the channels. The toner patches are printed with hydrophobic toner to apply inertial pressure to fluids travelling through the channels. The density of hydrophobic toner and the dimensions of the toner patch can be varied to alter the inertial pressure applied to the fluid. The chip can be rotated about a rotational axis to apply external pressure to fluids sufficient to overcome the inertial pressure created by the toner patch to push fluid past the toner patch. The rotational speed of the chip can be varied to facilitate movement of fluid through the channels and to push fluid past the hydrophobic toner patches.

### CLAIM OF PRIORITY

This patent application claims the benefit of priority, under 35 U.S.C. Section 119(e), to James P. Landers et al. U.S. Provisional Patent Application Ser. No. 61/885,328, entitled “RAPID AND DIRECT PATTERNING OF HYDROPHOBIC VALVES ON DISPOSABLE MICROCHIPS BY LASER PRINTER LITHOGRAPHY AND RELATED METHOD THEREOF,” filed on Oct. 1, 2013 (Attorney Docket No. 01973-01), which is hereby incorporated by reference herein in its entirety.

### TECHNICAL FIELD

This document pertains generally, but not by way of limitation, to microfluidic devices and methods of fabrication thereof.

### BACKGROUND

Lab-on-chip (“LOC”) microfluidic devices, in which a sample is analyzed in a single device or chip, have been optimized for a variety of applications including, for example, immunoassays, enzyme assays, the polymerase chain reaction, DNA analysis and sequencing, protein separation and single cell analysis. The microfluidic devices have been improved through incremental improvements focused on reducing analysis time, reagents consumed and sample volumes required. Recently, attention has been devoted to integrating sample preparation processes onto the microfluidic challenges to further improve the effectiveness and applicability of the microfluidic devices. However, integrating sample preparation in the microfluidic architecture requires isolating the preparation reagents from the analytical reagents during storage before selectively releasing the reagents to combine with the sample during sample preparation or analysis. As such, valves must be included in the microfluidic architecture to facilitate the selective movement of reagents within the microfluidic devices.

LOC microfluidic devices typically comprise a substrate in which the microfluidic architecture is printed, etched, molded or otherwise formed. The substrate typically comprises a polymeric material to reduce manufacturing and material costs. Currently, poly-dimethyl-siloxane (“PDMS”) is a preferred polymer for the substrate as multiple microfluidic devices can be quickly replicated from a template through a lithography process without the use of a clean room. Similarly, the elastomeric and hydrophobic properties of PDMS facilitate the use of mechanical and geometrically capillary valves. However, PDMS cannot be used for many routine biological and chemical assays as PDMS can be easily mechanically deformed, cause instability of surface treatments, gas permeability issues and absorb small hydrophobic molecules.

Alternate polymeric substrate materials include thermoplastics, such as Poly(ethylene terephthalate)-Toner (PeT), for which existing industrial fabrication processes such as multi-layer lamination, embossing and injection molding provide reduced production costs and improved production reliability. Unlike PDMS, the process for forming a PeT polymeric substrate having the appropriate microfluidic architecture involves printing a mirror image of the microfluidic architecture on a polyester film with a hydrophobic toner. A blank transparency film or a mirror printed sheet is then laminated on the first printed sheet, wherein the unprinted portions define the microfluidic architecture.

However, unlike PDMS microfluidic devices, integrating valving into the microfluidic architecture of PeT microfluidic devices is particularly difficult. The PeT substrate can be flimsy and easily damaged making it difficult to bond the elastomeric membranes necessary for mechanically-driven active valves without damaging the substrate. Similarly, non-mechanical active valves, such as phase-change valves, can malfunction due to being damaged by the heat and pressure applied during the final lamination step. In addition, both mechanically-driven and non-mechanical active valves require embedding of a different barrier material into the substrate, which can further complicate the fabrication process. In addition, active valves generally require an energy input to operate the valve increasing the complexity of the operation and decreasing the portability of the PeT microfluidic devices. Passive valves, such as geometrical capillary valves, only require sufficient driving force to overcome the surface tension of the liquid where the dimensions of the channel expand. However, the operational band pressure is determined by the aspect ratio of the channel structures, which are limited in PeT substrates by constraints of the lamination fabrication process making manipulation of liquid delivery difficult.

Although PeT substrates are often substantially less costly manufacture than PDMS and have certain advantageous material properties, the inability to integrate effective valving into the PeT substrate hinders the applications and effectiveness of PeT devices.

### OVERVIEW

The present inventors have recognized, among other things, that a problem to be solved can include the inability to control the flow of fluid through the microfluidic networks of microfluidic devices employing thermoplastics such as PeT. In an example, the present subject matter can provide a solution to this problem, such as by printing toner patches in fluid channels of a chip of a microfluidic device. The toner patches can comprise hydrophobic toner to apply inertial pressure to fluids travelling through the channels. The density of hydrophobic toner and the dimensions of the toner patch can be varied to alter the inertial pressure applied to the fluid. External pressure can be applied to overcome the inertial pressure created by the toner patch to push fluids past the toner patch. In an example, the chip can be rotated about a rotational axis to apply external pressure to fluids sufficient to overcome the inertial pressure created by the toner patch to push fluid past the toner patch. In certain examples, the external pressure can be applied by a syringe pump, electro-osomotic flow and headspace pressure from expanding gases or liquids. The external pressure can be positive pressure or a negative pressure from a vacuum drawing the fluid through the channel. The rotational speed of the chip can be varied to facilitate movement of fluid through the channels and to push fluid past the hydrophobic toner patches.

A laminate chip, according to an example, can include a bottom transparency film having a top surface having a toner patch printed thereon and a channel layer defining at least one elongated channel opening and having a toner bottom coat printed thereon. The bottom transparency film layer can be laminated to the bottom toner coat such that the channel opening and top surface cooperate to define a channel for receiving fluid, wherein the toner patch is aligned with the channel to create a hydrophobic region within the channel applying inertial pressure to fluid in the channel preventing fluid flow past the toner patch. The laminate chip can be rotatable to create external pressure on fluid received within the channel in excess to the inertial pressure to push the fluid past the hydrophobic region.

A method of fabricating a laminate chip, according to an example can include printing a toner patch on a top surface of a bottom transparency film layer and printing a bottom toner coat onto a channel layer. The method can further include ablating at least one channel opening in the channel layer. The method can also include laminating the bottom transparency film layer to the bottom toner coat of the channel layer such that the top surface of the bottom transparency film layer and the channel opening cooperate to define a channel, wherein the toner patch is positioned within the channel.

A method of controlling fluid flow through a laminate chip, according to an example, can include providing a channel layer including elongated channel opening and a bottom toner coat and laminating a bottom transparency film layer having a toner patch to the bottom toner coat to define a channel, wherein the toner patch is positioned within the elongated channel. The toner patch can comprise a hydrophobic toner. The method can further comprise administering fluid into the channel. The toner patch can create inertial pressure on the fluid preventing the fluid from passing the toner patch. The method can also include rotating the laminate chip about a rotational axis to exert an external pressure on the fluid in excess of a predetermined threshold to overcome the inertial pressure to push the fluid past the toner patch.

This overview is intended to provide an overview of subject matter of the present patent application. It is not intended to provide an exclusive or exhaustive explanation of the present subject matter. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an exploded view of a laminate chip according to an example of the present disclosure.

FIG. 2 is a schematic diagram illustrating a method for fabricating a laminate chip according to an example of the present disclosure.

FIG. 3 is an exploded view of a laminate chip according to an example of the present disclosure, wherein toner patches have been printed onto transparency film layers and toner coats have been printed onto a meter layer.

FIG. 4 is a diagram illustrating varying toner density of a toner patch according to an example of the present disclosure.

FIG. 5 is an exploded view of the laminate chip depicted in FIG. 3, wherein the printed transparency film layer and the printed channel layer have been ablated to form a microfluidic architecture.

FIG. 6A is a perspective view of the laminate chip depicted in FIG. 5, assembled according to an example of the present disclosure.

FIG. 6B is a perspective view of a toner patch of the laminate chip depicted in FIG. 6A.

FIG. 6C is a cross-sectional side view of the toner patch of the laminate chip depicted in FIG. 6B.

FIG. 7A is a perspective view of a polar fluid in a channel of a laminate chip approaching a toner patch according to an example of the present disclosure.

FIG. 7B is a diagram illustrating a meniscus of a polar fluid being drawn through a laminate chip approaching a toner patch according to an example of the present disclosure.

FIG. 8A is a perspective view of a polar fluid in a channel of a laminate chip obstructed by a toner patch according to an example of the present disclosure.

FIG. 8B is a diagram illustrating a meniscus of a polar fluid being drawn through a laminate chip obstructed by a toner patch according to an example of the present disclosure.

FIG. 9 is a schematic view of a laminate chip according to an example of the present disclosure.

FIG. 10A is a perspective view of a metering section of a laminate chip according to an example of the present disclosure.

FIG. 10B is a perspective view of the metering section depicted in FIG. 10A, wherein fluid has filled a metering channel of the metering section and excess fluid is shunted out an overflow channel.

FIG. 10C is a perspective view of the metering section depicted in FIG. 10A, wherein a predetermined quantity of fluid in the metering channel is being pushed across a hydrophobic valve.

FIG. 11 is a top view of an assembled laminate according to an example of the present disclosure.

FIG. 12 is an exploded view of a laminate chip according to an example of the present disclosure.

FIG. 13 is a side cross-sectional view of a laminate chip according to an example of the present disclosure.

FIG. 14 is a perspective view of a laminate chip according to an example of the present disclosure.

### DETAILED DESCRIPTION

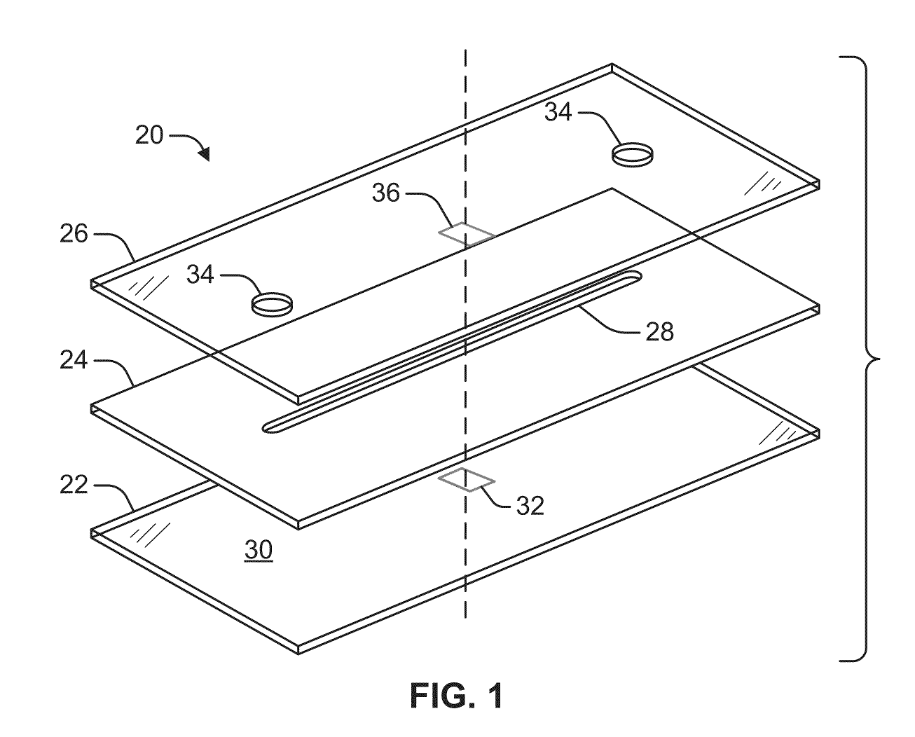

As depicted in FIG. 1, a laminate chip 20 having microfluidic architecture, according to an example, can include a bottom transparency film layer 22, a channel layer 24 and a top transparency film layer 26. The channel layer 24 can include a microfluidic architecture having at least one elongated channel opening 28. A hydrophobic toner can be printed on both sides of the channel layer 24 to form a toner top coat and a toner bottom coat. The bottom transparency film layer 22 can further include a top surface 30 on which at least one toner patch 32 is printed. The bottom transparency film layer 22 can be adhered to the toner bottom coat of the channel layer 24 such that the top surface 30 of the bottom transparency film layer 22 and the channel opening 28 cooperate to define a channel through which fluid can be drawn. The top transparency film layer 26 can be adhered to the toner top coat to enclose the channel. In certain examples, the top transparency film layer 26 includes at least one port 34 intersecting the elongated channel opening 28 to administer or withdraw fluid from the channel. The toner patch 32 can be positioned within the channel opening 28 to form a hydrophobic region within the channel that acts as a passive hydrophobic valve selectively restricting fluid flow through the channel. In certain examples, the top transparency film layer 26 can include an additional toner patch 36 on a bottom surface of the top transparency fluid film layer 26 cooperating with the toner patch 32 to selectively restrict flow through the channel.

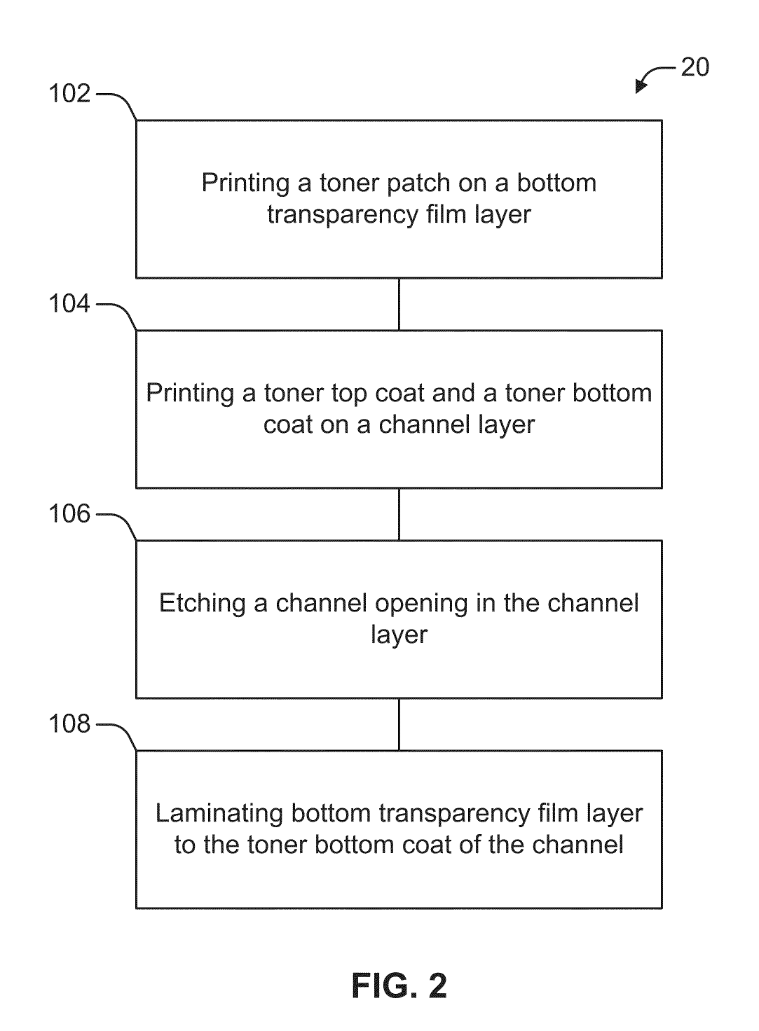

As depicted in FIG. 2, in an example, a method 100 for fabricating a laminate chip 20, according to an example, can include toner patch printing 102, toner coat printing 104, architecture etching 106 and layer lamination 108.

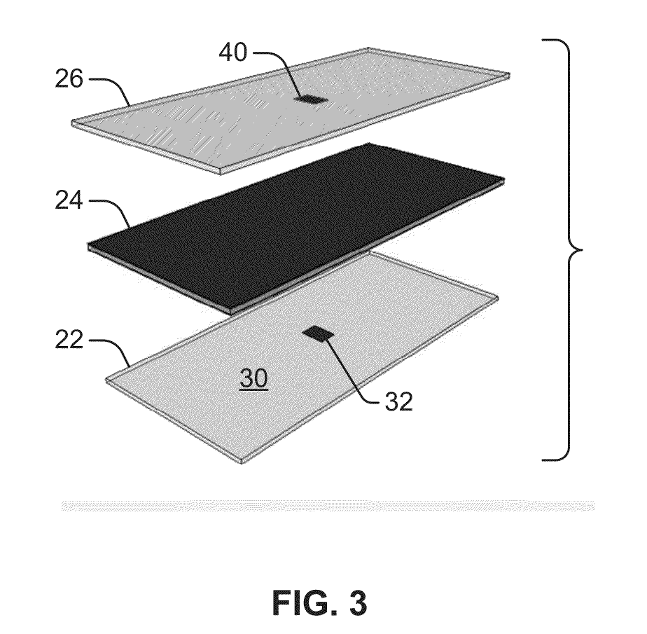

As depicted in FIG. 3, at toner patch printing 102, at least one toner patch 32 is printed on a top surface 30 of the bottom transparency film layer 22. The toner patch 32 comprises a hydrophobic toner that can be applied with a stamping apparatus, a laser printer, an inject printer, screen printing or apparatus or other apparatus for depositing a pattern of toner marks. As depicted, the toner patch 32 is applied by printing. In certain examples, the toner patch 32 can be applied by embossing, stamping, deposition or other methods of applying a toner onto the layers. The hydrophobic toner can comprise sufficient hydrophobicity to create a contact angle between about 90 degrees and about 115 degrees when a deionized water droplet is placed on a surface printed with the hydrophobic toner. The transparency film layer 22, the channel layer 24 and the top transparency film layer 26 can comprise PeT sheets, but can comprise other hydrophilic thermoplastic polymers and super-hydrophilic materials. In certain examples, the transparency film layer 22, channel layer 24 and the top transparency layer 26 can comprise hydrophobic material while the applied toner can be hydrophilic. In this configuration, the laminate chip can be used with organic solvents and similar hydrophobic fluids. The hydrophobic toner can create a hydrophobic region on the otherwise hydrophilic sheets. In an example, at least one additional toner patch 36 can be printed on a bottom surface of the top transparency film layer 26. The additional toner patch 36 can be positioned to align with the toner patch 32 or be positioned elsewhere on the bottom surface of the top transparency film layer 26.

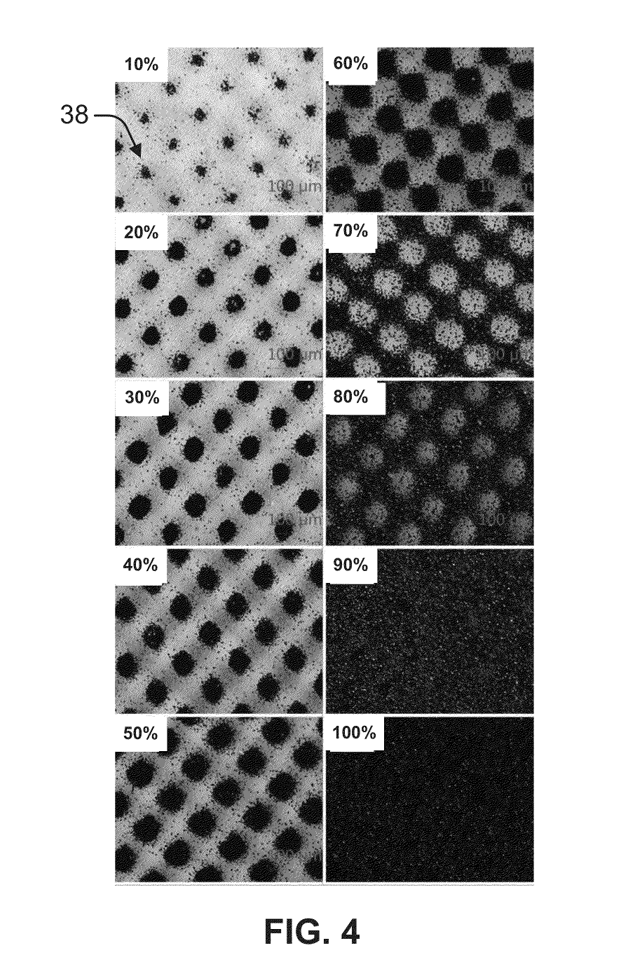

As depicted in FIG. 4, in an example, the toner patch 32 can comprise a micropattern of a plurality of printed toner marks 38. The toner patch 32 can comprise predetermined length and width, wherein the density of the toner marks within the toner patch 32 can be varied to change the fractional area of the toner patch 32 covered by toner. As illustrated in FIG. 4, the toner mark density can range from minimal coverage of less than 10% to completely coverage. The fractional area of the toner patch 32 covered by toner alters the effective hydrophobicity of the printed toner patch 32. The overall hydrophobicity of the toner patch 32 can be determined by evaluating change in contact angle as the characteristics of the toner patch 32 is varied and can be expressed by:

cos θ_{Toner patch}=f₁(cos θ_{Toner}−cos θ_{Transparency film})+cos θ_{Transparency film}

where f1 (0≦f1≦1) is the fractional area of exposed toner-coated surface; cos θ_{Transparency film} is the contact angle of the liquid on uncoated transparency film; cos θ_{Toner} is the contact angle of the liquid on fully coated transparency film; and cos θ_{Toner patch} is the contact angle of the liquid on the resulting toner patch 32. In an example, the toner patch 32 and a cooperating additional toner patch 40 can have the same fractional area coverage to have uniform hydrophobicity. In another example, the toner patch 32 and the toner patch 40 can have different fractional area coverage to have different hydrophobicity.

As also depicted in FIG. 3, at printing 104, a toner top coat and a toner bottom coat are printed on the channel layer 24. The channel layer 24 can comprise a PeT sheet, but can comprise other hydrophilic thermoplastic polymers or super-hydrophilic materials. Also, as discussed above, the channel layer 24 can comprise hydrophilic materials to correspond to the properties of the fluid being drawn through the channel. The toner top coat and the toner bottom coat can fully coat the top and bottom surfaces of the channel layer 24. The toner top coat and the toner bottom coat create hydrophobic top and bottom surfaces on the channel layer 24.

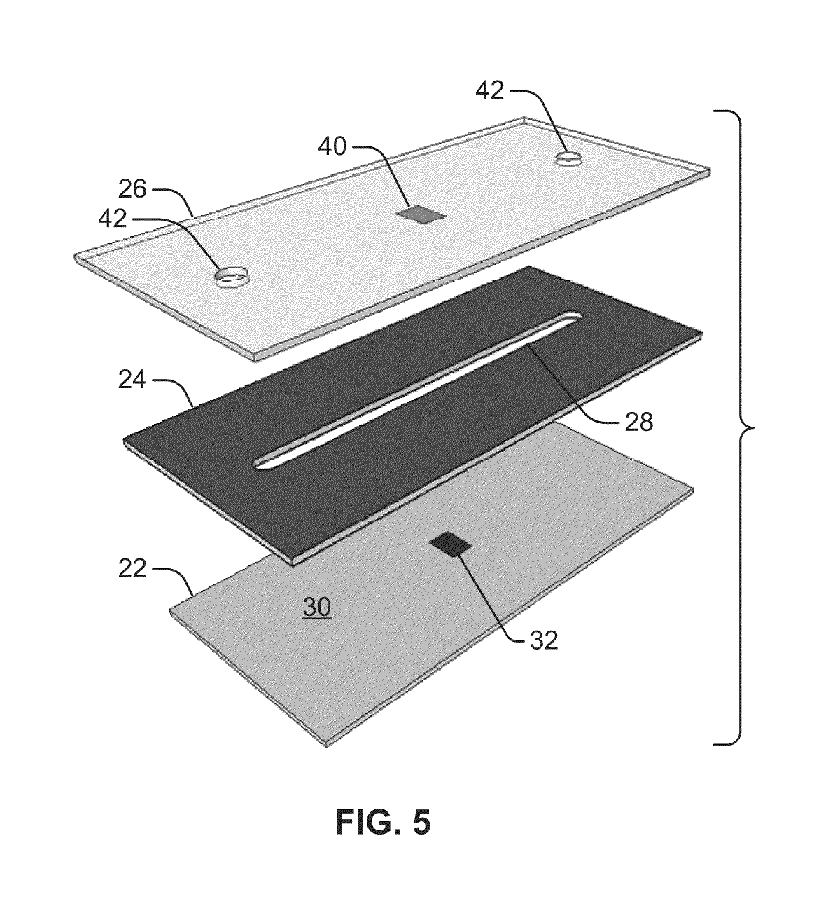

As depicted in FIG. 5, at architecture etching 106, at least one elongated cannel opening 28 is ablated through the channel layer 24. As further discussed below, in certain examples, a plurality of different structures can be ablated in the channel layer 24. The elongated channel opening 28 or other structures can be ablated with a laser such as a CO₂ laser. The ablation can form the channel opening 28 such that the walls of the channel opening 28 are substantially free of the hydrophobic toner exposing the hydrophilic film. The width of the channel opening can be between about 250 μm to about 800 μm wide. In certain examples, top transparency film layer 26 can be ablated to form at least one port 34 at an end of the elongated channel opening 28 for administering or withdrawing fluid from the elongated channel opening 28.

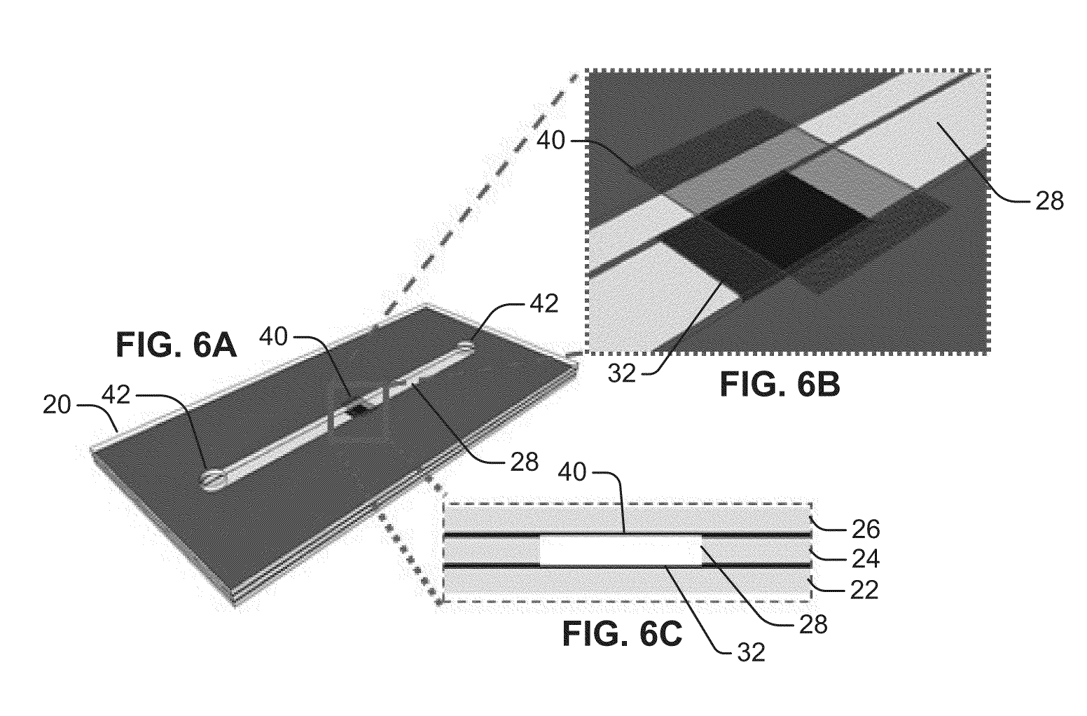

As depicted in FIGS. 6A-6C, at lamination 108, the bottom transparency film 22 is adhered to the bottom coat of the channel layer 24. The top surface 30 of the bottom coat of the channel layer 24 and the channel opening 28 cooperate to define a channel as illustrated in FIG. 6B-6C. In an example, the top transparency film layer 26 can be adhered to the top coat of the channel layer 24 to enclose the channel. The hydrophilic walls of the channel opening 28 and the width of the channel opening 28 can draw fluid through the channel by capillary action. The thickness of the channel layer 24, toner top coat and the toner bottom coat defines the height of the resulting channel. In an example, the height of the channel can be about 130 μm to about 270 μm. As discussed further below, multiple channel layers can be stacked to increase the effective height of the channel. The toner patch 32 can be positioned on the top surface 30 of the bottom transparency film 22 to align with the channel opening 28. In an example, the additional toner patch 40 on the bottom surface of the top transparency film layer 26 is aligned with the toner patch 32 on the bottom transparency film 22 as illustrated in FIG. 6B.

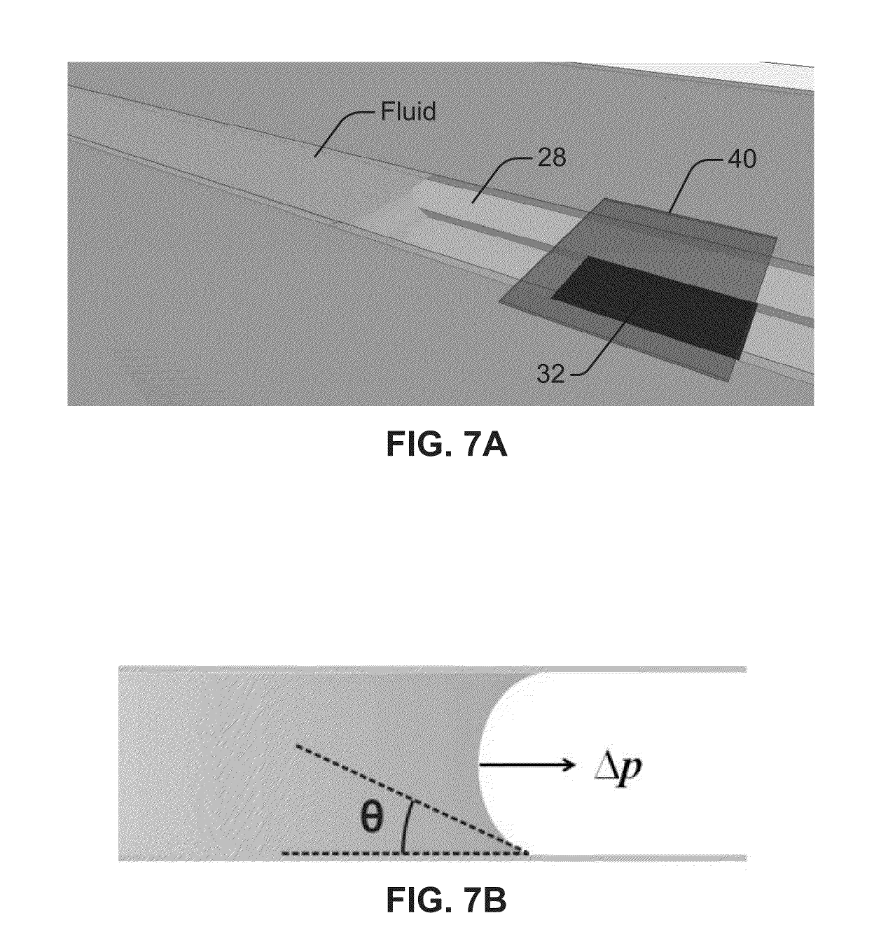

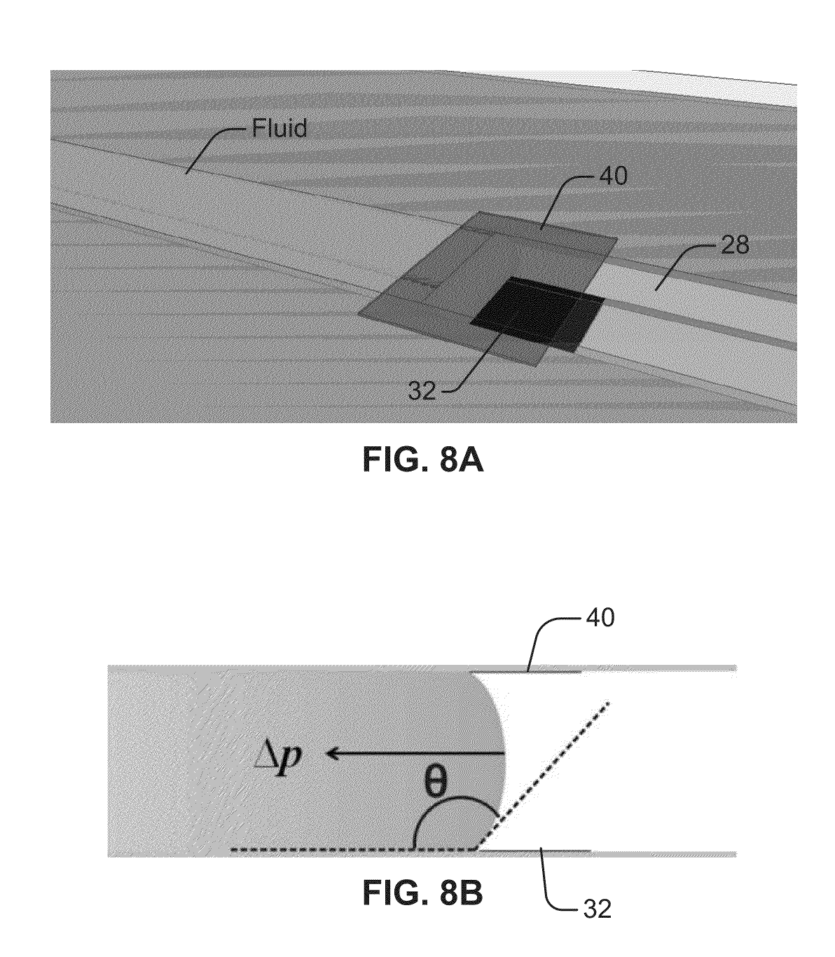

In operation, as illustrated in FIGS. 7A-7B, the walls of the channel opening 28 can be hydrophilic creating a pressure differential drawing fluid administered into the channel through the channel. As illustrated in FIGS. 8A-8B, the toner patch 32 or toner patches 32, 40 create a hydrophobic region in the channel acts as a passive valve applying an inertial pressure on fluid being drawn through the channel by the hydrophilic walls of the channel opening 28 to prevent flow of fluid past the toner patch 32. The inertial pressure generated by the passive valve created by the toner patch 32 is a function of the dimensions of the channel and the characteristics of toner patch and can be expressed by:

$${p}_{1} = 2 γ [ \frac{cos {θ}_{wall}}{w} + \frac{{f}_{1} ( cos {θ}_{Toner} - cos {θ}_{Transparency film} ) + cos {θ}_{Transparency film}}{h} ]$$

where γ is the surface tension of the fluid; w is the channel width; h is the channel height; and cos θ_{Toner} is the contact angle along the sidewall of the channel.

The hydrophobic valve created by the toner patch 32 prevents flow of fluid through the channel until the pressure of the fluid exceeds the inertial pressure created by the toner patch 32. The capillary pressure generated by the fluid column is a function of the channel dimensions and can be expressed by:

$${p}_{2} = ρ gH 2 γ ( \frac{cos {θ}_{wall}}{w} + \frac{cos {θ}_{Transparency film}}{h} )$$

where ρ is the density of the fluid; g is the gravitational acceleration and H is the height of the fluid column. In an example, the dimensions and density of the toner patch 32 is such that the inertial pressure created by created by the toner patch 32 is at least greater than the capillary pressure such that without additional outside pressure the toner patch 32 will restrict fluid flow through the channel.

In an example, external pressure can be generated by applying pressure to the fluid through a syringe pump or from headspace pressure from expanding gases or liquids. The external pressure created can be positive pressure pushing the fluid past the hydrophobic valve or negative pressure drawing the fluid past the hydrophobic valve. In an example, an electrical potential can be applied to the laminate chip 20 to induce electro-osmotic flow within the channel to create sufficient external pressure to overcome the inertial pressure generated by the hydrophobic valves.

In an example, external pressure can be generated by rotating the laminate chip 20 about a rotational axis, wherein the channel is oriented to extend radially outward from the rotational axis. The centrifugal force from the rotation of the laminate chip 20 creates external pumping pressure on the fluid within the channel such that the overall pressure of the fluid reaches a burst pressure that exceeds the inertial pressure of the hydrophobic valve. The pumping pressure generated by rotation of the laminate chip is a function of the distance of the fluid from the center of the rotational axis and can be expressed by:

$$Δ P = {ρω}^{2} ( {R}_{2} - {R}_{1} ) ( \frac{{R}_{2} - {R}_{1}}{2} ) = {ρω}^{2} \cdot Δ R \cdot \overline{R}$$

where ω is the angular velocity of the rotating the laminate chip; R₁ is the initial distance of the fluid from the rotational axis; R₂ is the final distance of the fluid from the rotational axis; ΔR is equal to R₂−R₁; and is equal to (R₂+R₁)/2. The burst pressure is a function of the toner patch characteristics and the geometry of the channel and can be expressed for a channel having a uniform width and depth, by:

$${p}_{3} = 2 {f}_{1} \frac{γ}{h} ( cos {θ}_{Transparency film} - cos {θ}_{Toner} ) .$$

The necessary rotational frequency necessary to provide flow through across the toner patch 32 can be expressed by:

$$f = \frac{30}{π} \sqrt{\frac{2 {f}_{1} γ ( cos {θ}_{Transparency film} - cos {θ}_{Toner} )}{ρ \cdot h \cdot Δ R \cdot \overline{R}}} .$$

In an example, the dimensions and density of the toner patch 32 can be selected to have an inertial pressure exceeding the capillary pressure by a predetermined amount requiring a minimum rotational speed to generate a predetermined pumping pressure to push fluid past the hydrophobic valve. As discussed further below, in certain examples, the laminate chip 20 can comprise a plurality of toner patches 32 each having different dimensions and densities to provide selective fluid flow the various hydrophobic valves.

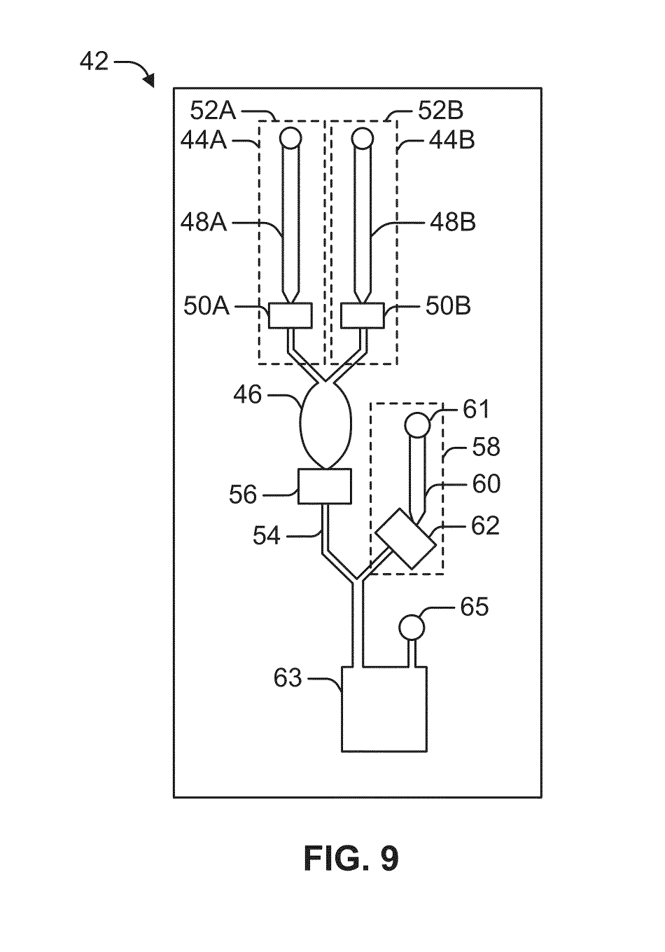

As depicted in FIG. 9, a laminate chip 42, according to an example, can include a microfluidic architecture having a first branch 44A, a second branch 44B and at least one mixing chamber 46. As depicted, the laminate chip 20 includes two branches 44A, 44B, but can be readily adapted to link a plurality of branches to the mixing chamber 46. The first branch 44A can further include a channel 48A fluidly connected to the mixing chamber 46 and a hydrophobic valve 50A positioned to control fluid flow into the mixing chamber 46 from the channel 48A. In an example, the first branch 44A can further include a port 52A for administering fluid into the channel 48A. The second branch 44B can further include a channel 48B fluidly connected to the mixing chamber 46 and a hydrophobic valve 50B positioned to control fluid flow into the mixing chamber 46 from the channel 48B. In an example, the second branch 44B can further include a port 52B for administering fluid into the channel 48B. In certain examples, the channels 48A, 48B can be sized to receive a predetermined quantity of fluid.

In an example, the toner patch for the hydrophobic valve 50A of the first branch 44A can have a different dimension and/or density from the toner patch for the hydrophobic valve 50B of the second branch 44B. In this configuration, the laminate chip 42 can be rotated at a first rotational speed corresponding to the first hydrophobic valve 50A to allow fluid to enter the mixing chamber 46 from the first branch 44A. The laminate chip 42 can then be rotated at a second rotational speed corresponding to the second hydrophobic valve 50B to allow fluid to enter the mixing chamber 46 from the second branch 44B. In this configuration, the order, rate and other characteristics of the mixing of fluids from the branches 44A, 44B into the mixing chamber 46 can controlled by varying the rotational speed of the laminate chip 20. In certain examples, the toner patch for the hydrophobic valve 50A of the first branch 44A can have the same dimensions and/or density as the toner patch for the hydrophobic valve 50B of the second branch 44B. In this configuration, the branches 44A, 44B can simultaneously feed fluid into the mixing chamber 46. In certain examples, the laminate chip 42 can include a plurality of branches having combinations of hydrophobic valves having varying effective rotational speeds for controlling mixing of fluids in the mixing chamber 46.

As also depicted in FIG. 9, in certain examples, the microfluidic architecture can further include an exit channel 54 for evacuating fluids from the mixing chamber 46. The exit channel 54 can further include a hydrophobic valve 56 for controlling the release of fluid from the mixing chamber 46. The dimensions and density of the toner patch for the hydrophobic valve 56 can be set to require a different rotational speed for the laminate chip 20 than the rotational speeds required to overcome the hydrophobic valves 50A, 50B of the first and second branches 44A, 44B. In an example, the required rotational speed for the hydrophobic valve 56 of the exit channel 54 can be greater than the required rotational speeds for the hydrophobic valves 50A, 50B of the first and second branches 44A, 44B. In this configuration, the fluids from the first and second branches 44A, 44B can be initially mixed within the mixing chamber 46 before being evacuated through the exit channel 54. The mixed fluids within the mixing chamber 46 can also be retained within the mixing chamber 46 for a predetermined period of time to complete reactions, such as for sample preparation, or other purposes before being evacuated through the exit channel 54. In certain examples, The dimensions and density of the toner patch for the hydrophobic valve 56 can be set to require the same rotational speed for the laminate chip 20 as the rotational speeds required to overcome the hydrophobic valves 50A, 50B of the first and second branches 44A, 44B. In this configuration, fluids are being evacuated from the mixing chamber 46 at the same rate the fluids are being fed into the mixing chamber 46 from the branches 44A, 44B.

As also depicted in FIG. 9, in an example, the microfluidic architecture can include a secondary branch 58 intersecting the exit channel 54. The secondary branch 58 can also be configured to intersect another channel of the microfluidic architecture. The secondary branch 58 can further include a secondary channel 60 fluidly connected to the exit channel 54 and a hydrophobic valve 62 controlling the flow of fluid from the secondary channel 64 into the exit channel 54. In an example, the secondary branch 58 can further include a port 61 for administering fluid into the channel 60. The toner patch for the hydrophobic valve 62 can correspond in size and density to the hydrophobic valve 56 for the exit channel 54. In this configuration, the hydrophobic valves can be opened at the same rotational speed to such that fluids from the channels 54, 60 intermix. The secondary branch 58 can be used to administer additional fluids, such as preparation reagents, as fluids flow through the channels for further processing of fluids prior to reaching a reaction chamber 63. In an example, the reaction chamber 63 can include an additional port 65 for administering fluids directly into the reaction chamber 63.

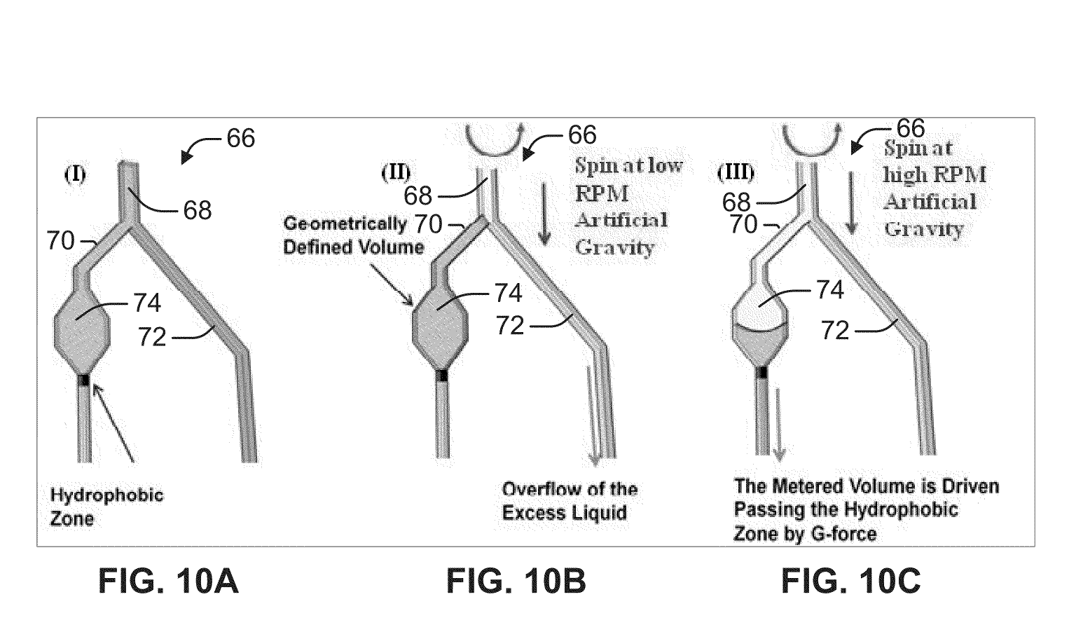

As depicted in FIGS. 10A-10C, a laminate chip 64, according to an example, can include a metering section 66 for providing predetermined quantities of fluids. The metering section 66 includes an entry channel 68 fluidly connected to a metering channel 70 and an overflow channel 72. The metering channel 70 further includes a measuring chamber 74 and a hydrophobic valve 76. As illustrated in FIG. 10B, fluid entering the entry channel 68 enters the measuring chamber 74 where the fluid is retained by the hydrophobic valve 76. The laminate chip 64 can be rotated at a lower rotational speed to apply pressure on the fluid to force the fluid into the measuring chamber 74 without sufficient pressure to overcome the hydrophobic valve 76. The measuring chamber 74 can be sized to receive a predetermined volumetric quantity of fluid. Excess fluid not directed into the measuring chamber 74 or after the measuring chamber 74 is full is directed down the overflow channel 72. In an example, the excess fluid can be fed into a second metering section 66 to fill a second measuring chamber 74 or used for other purposes. As illustrated in FIG. 10C, the laminate chip 64 can be rotated at rotational speed applying sufficient pressure on the fluid to empty the measuring chamber 74. The metering section 66 measures and delivers a predetermined volume of fluid.

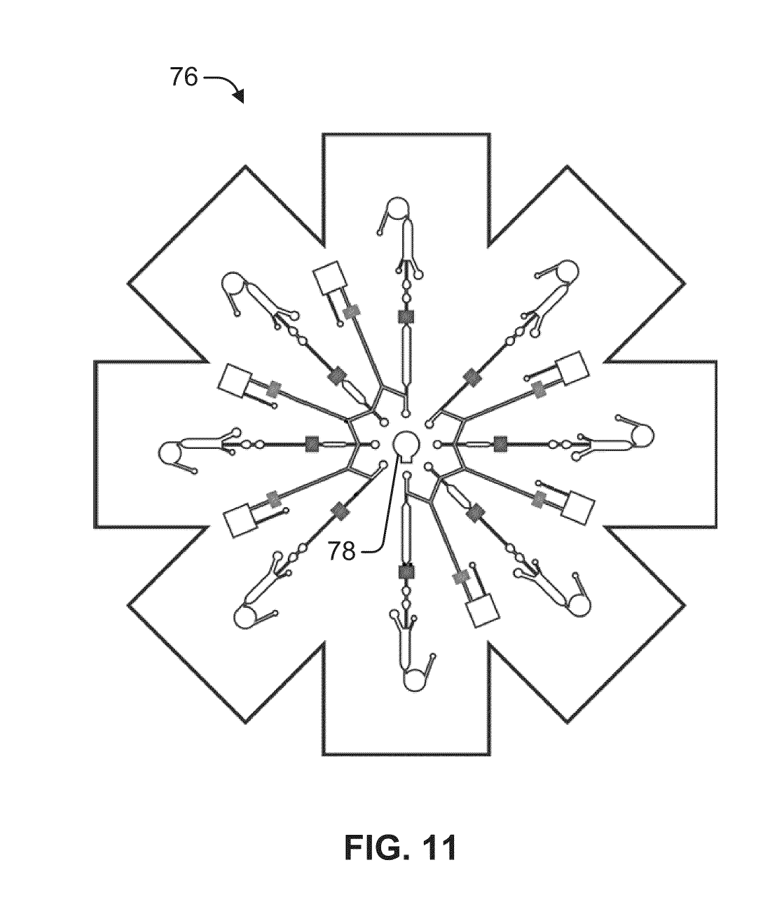

As depicted in FIG. 11, in an example, a laminate chip 76 can include a rotational mount 78 for operably engaging the laminate chip 76 to a rotatable spindle or other apparatus for rotating the laminate chip 76 about the rotational axis to push the fluid past the toner patch 32. As illustrated in FIG. 11, the laminate chip 20 can include a plurality of microfluidic networks, such as depicted in FIG. 9, extending radially outward from the rotational mount 78. The radial configuration allows a plurality of different processes to be performed in parallel. In an example, the laminate chip 76 can further include at least one connector channel 80 fluidly connecting at least two of the microfluidic networks. In this configuration, a fluid, such as a test sample, can be administered into the connector channel 80 and distributed to a plurality of microfluidic networks.

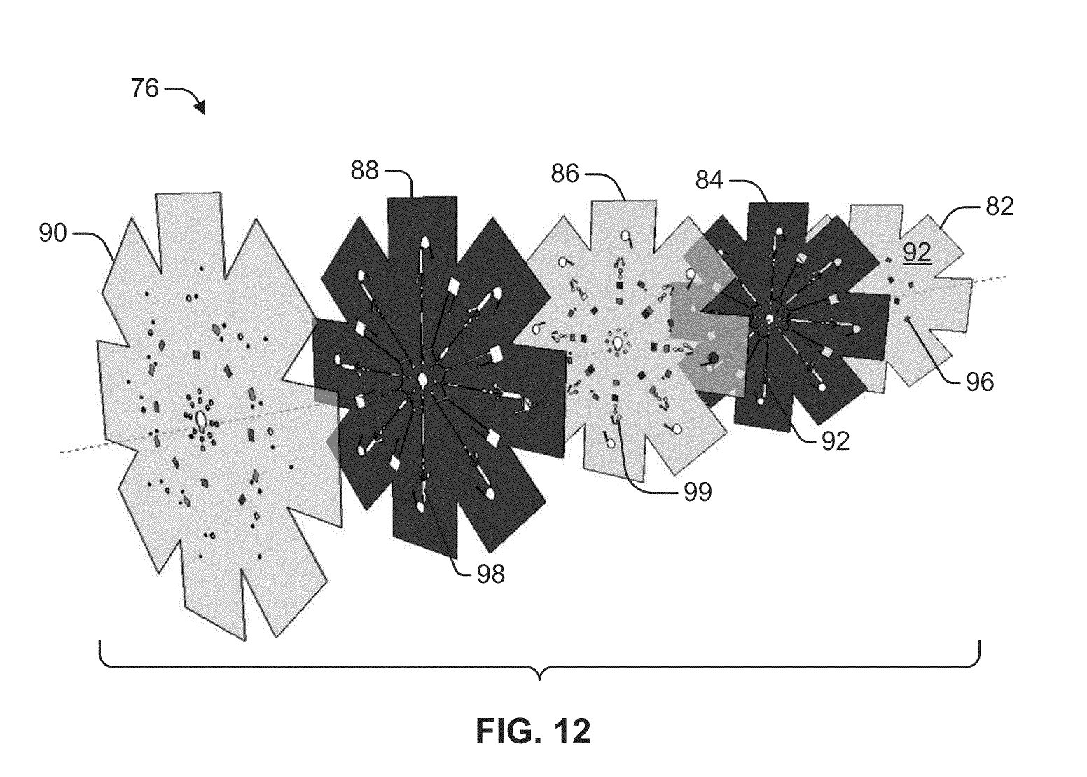

As depicted in FIG. 12, the laminate chip 76, in certain examples, can include a bottom transparency film layer 82, a bottom channel layer 84, at least one middle transparency film layer 86, at least one intermediate channel layer 88 and a top transparency film layer 90. The bottom channel layer 84 can include a microfluidic architecture having at least one elongated channel opening 92. A hydrophobic toner can be printed on both sides of the bottom channel layer 84 to form a toner top coat and a toner bottom coat. The bottom transparency film layer 82 can further include a top surface 94 on which at least one toner patch 96 is printed. The bottom transparency film layer 82 can be adhered to the toner bottom coat of the bottom channel layer 84 such that the top surface 94 of the bottom transparency film layer 82 and the channel opening 92 cooperate to define a channel through which fluid can be drawn. Each intermediate channel layer 88 can include at least one intermediate channel opening 98. A hydrophobic toner can be printed on both sides of the intermediate channel layer 88 to form a toner top coat and a toner bottom coat. In this configuration, a first middle transparency film layer 86 can be adhered to the toner top coat of the bottom channel layer 84 and the toner bottom coat of the first intermediate channel layer 88 can be adhered to the opposite side of the first middle transparency film layer 86. The top transparency film layer 90 or a second middle transparency film layer 86 can be adhered to the top coat of the first intermediate channel layer 88. In certain example, each middle transparency layer 34 can include at least one port 99 or elongated channel opening fluidly connecting the channel opening 92 defined by the bottom channel layer 92 with the intermediate channel opening 98 defined by the intermediate channel layer 88 to define a continuous flow path. In other examples, the middle transparency film layer 86 separates the channel openings 92, 98 of adjacent channel layers 84, 88 to define at least two separate flow paths.

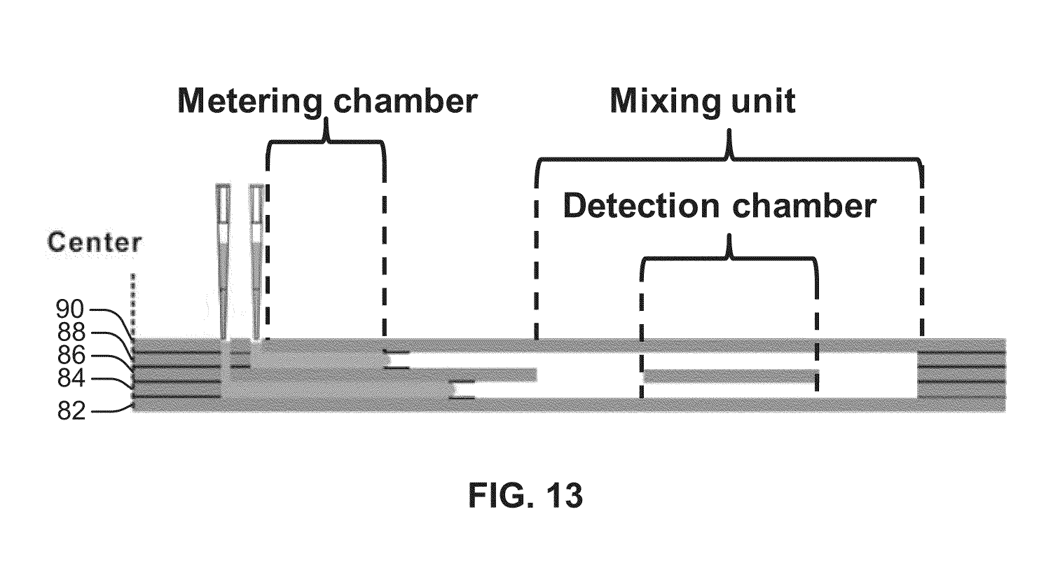

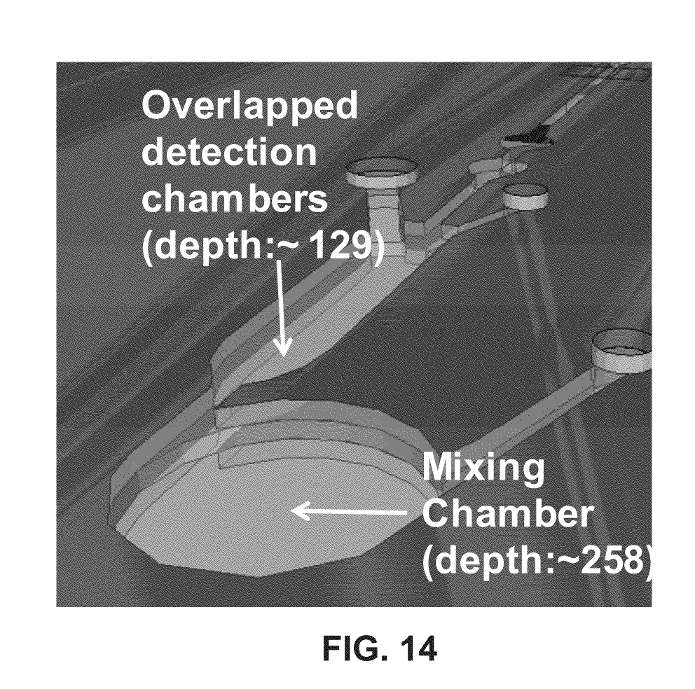

As illustrated in FIGS. 13 and 14, in an example, the bottom channel layer 84, middle transparency film layers 86 and intermediate channel layers 88 can each ablated with a plurality of different microfluidic structures. In certain examples, the intermediate channel layers 88 operate to isolate the microfluidic structures of adjacent channel layers 88 such that fluids can be retained and moved within the respective microfluidic structures without intermixing. As discussed above, in certain examples, the intermediate channel layers 88 can have ports 99 that fluidly connect the microfluidic structures of adjacent channel layers 88 to provide chambers having increased height for mixing of fluids or reactions as illustrated in FIG. 14. In certain examples, the intermediate channel layers 88 can form shallow regions within the mixing chambers to isolate a portion of the mixed fluid for improved detection and analysis as depicted in FIG. 13.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

What is claimed is:

1. A laminate chip, comprising:
a bottom transparency film having a top surface having a toner patch printed thereon;
a channel layer defining at least one elongated channel opening and having a toner bottom coat printed thereon; and
wherein the bottom transparency film layer is laminated to the bottom toner coat such that the channel opening and top surface cooperate to define a channel for receiving fluid, wherein the toner patch is aligned with the channel to create a hydrophobic region within the channel applying inertial pressure to fluid in the channel preventing fluid flow past the toner patch.

2. The laminate chip of claim 1, wherein the laminate chip is rotatable to create external pressure on fluid received within the channel in excess to the inertial pressure to push the fluid past the hydrophobic region.

3. The laminate chip of claim 1, wherein the laminate chip further comprises:
a top transparency film layer having a bottom surface;
wherein the channel layer having a toner top coat printed opposite the toner bottom coat, wherein the bottom surface of the top transparency film layer is laminated to the toner top coat of the channel layer.

4. The laminate chip of claim 3, wherein the top transparency includes an additional toner patch printed on the bottom surface.

5. The laminate chip of claim 3, wherein the top transparency includes at least one port positioned to intersect the channel.

6. The laminate chip of claim 3, wherein the laminate chip further includes:
at least one middle transparency film layer; and
at least one intermediate channel layer corresponding to one of the at least one middle transparency layer, the intermediate channel layer having a top toner coat and a bottom toner coat printed thereon;
wherein the at least one middle transparency film layer and the at least one intermediate channel layer are alternatingly stacked between the bottom transparency film layer and the top transparency film layer.

7. The laminate chip of claim 6, wherein at least one of the middle transparency film layer and the intermediate channel layer includes an intermediate channel opening corresponding to the channel opening of the metering transparency layer;
wherein the intermediate channel opening aligns with the channel opening of the channel layer to increase the effective height of the channel.

8. The laminate chip of claim 7, wherein the middle transparency film layer isolates a portion of the intermediate channel opening of the intermediate channel layer from the channel opening of the channel layer.

9. The laminate chip of claim 1, wherein the toner patch comprises a hydrophobic toner.

10. The laminate chip of claim 1, wherein the bottom transparency film and the channel layer comprises poly-ethylene terephthalate.

11. The laminate chip of claim 1, wherein each toner patch comprises a plurality of printed toner marks.

12. The laminate chip of claim 11, wherein the density of printed marks can be varied to alter the inertial pressure created by the toner patch.

13. The laminate chip of claim 1, wherein the channel further comprises an expanded volume portion adjacent to the toner patch for receiving a quantity of fluid.

14. The laminate chip of claim 1, wherein the laminate chip is rotatable about a rotational axis;
wherein the channel is oriented to extend radially outward from the rotational axis.

15. A method of fabricating a laminate chip, comprising:
printing a toner patch on a top surface of a bottom transparency film layer;
printing a bottom toner coat onto a channel layer;
ablating at least one channel opening in the channel layer; and
laminating the bottom transparency film layer to the bottom toner coat of the channel layer such that the top surface of the bottom transparency film layer and the channel opening cooperate to define a channel, wherein the toner patch is positioned within the channel.

16. The method of claim 15, further comprising:
printing a top toner coat onto the channel layer; and
laminating a bottom surface of a top transparency film to the top toner coat.

17. The method of claim 16, further comprising:
printing an additional toner patch on a bottom surface of the top transparency film layer.

18. A method of controlling fluid flow through a laminate chip, comprising:
providing a channel layer including elongated channel opening and a bottom toner coat;
laminating a bottom transparency film layer having a toner patch to the bottom toner coat to define a channel, wherein the toner patch is positioned within the elongated channel, wherein the toner patch comprises a hydrophobic toner;
administering fluid into the channel, wherein the toner patch creates inertial pressure on the fluid preventing the fluid from passing the toner patch; and
exerting an external pressure on the fluid in excess of a predetermined threshold to overcome the inertial pressure to push the fluid past the toner patch.

19. The method of controlling fluid flow of claim 18, further comprising:
varying a density of hydrophobic toner of the toner patch to alter the hydrophobicity of the toner patch to alter the inertial pressure applied to the fluid.

20. The method of controlling fluid flow of claim 19, wherein the external pressure is generated by rotating the laminate chip about a rotational axis.

21. The method of controlling fluid flow of claim 20, further comprising:
rotating the laminate chip at a rotational speed creating an external pressure less than the predetermined threshold to push the fluid up to the toner patch, wherein the inertial pressure prevents the fluid from passing the toner patch.

22. The method of claim 18, further comprising:
printing a second toner patch on the bottom transparency film layer having a different density of hydrophobic toner than the first toner patch;
rotating the laminate chip at a different rotational speed to exert a second external pressure on the fluid in excess of a second predetermined threshold to over the inertial pressure created by the second toner patch to push the fluid past the second toner patch.
